(19) United States
(12) Patent Application Publication
(10) Pub. No.: US 2024/0062670 A1
(43) Pub. Date: Feb. 22, 2024

(54) AUDIOVISUAL THERAPY DEVICE

(71) Applicant: Jigsawdio, Raleigh, NC (US)

(72) Inventors: Amy Marie Young, Raleigh, NC (US); Brendan Young, Raleigh, NC (US)

(21) Appl. No.: 18/452,120

(22) Filed: Aug. 18, 2023

Related U.S. Application Data
(60) Provisional application No. 63/371,968, filed on Aug. 19, 2022.

(51) Int. Cl. G09B 5/06

(52) U.S. Cl. CPC G09B 5/06

(57) ABSTRACT

An audiovisual therapy device designed to provide memory training and mental stimulation is disclosed. The audiovisual therapy device includes a frame assembly designed to receive a plurality of puzzle pieces and a plurality of audio files corresponding to the plurality of puzzle pieces. The audiovisual therapy device is designed to play at least one audio file based on a selected puzzle piece of the plurality of puzzle pieces.

### CROSS-REFERENCE TO RELATED APPLICATIONS

This application claims the benefit of U.S. Provisional Application No. 63/371,968 filed Aug. 19, 2022, the entire content of which is incorporated by reference herein in its entirety.

### BACKGROUND

In 2022, approximately 6.5 million individuals suffered from Alzheimer's disease. On average, individuals aged 65 or older survive between four to eight years after a diagnosis of Alzheimer's disease. Signs of Alzheimer's include short-term memory loss (e.g., asking the same questions over and over), problem-solving challenges, trouble completing familiar tasks, confusion with time, trouble understanding visual images and spatial relationships, and misplacing things. Generally, methods of treating Alzheimer's disease can be split between drug-related treatments and non-drug treatments. Non-drug treatments do not change the underlying biology of the disease. However, non-drug treatments are designed to maintain or improve cognitive function, overall quality of life and engagement, and the ability to perform activities of daily living. Examples of non-drug treatments include cognitive stimulation, music-based therapies, and psychological treatment (e.g., cognitive behavioral therapy). In addition to training cognitive functions, non-drug treatments also help with reducing behavioral symptoms such as depression, apathy, wandering, sleep disturbances, agitation, and aggression. Proactive management of Alzheimer's disease can improve the quality of life of affected individuals and their caregivers.

### FIELD OF THE INVENTION

The present invention is generally related to audiovisual therapy devices for individuals suffering from Alzheimer's disease, and more specifically to jigsaw puzzles designed for individuals suffering from Alzheimer's disease.

### DESCRIPTION OF RELATED ART

Current non-drug treatments for Alzheimer's disease include memory training, mental and social stimulation, and physical exercise programs. Non-drug solutions include jigsaw puzzles designed for memory training and mental stimulation. However, jigsaw puzzles are limited in the amount of training and stimulation they provide to an individual suffering from Alzheimer's disease. Typically, a jigsaw puzzle has a preset image that is unrelated to an individual. Additionally, jigsaw puzzles are not interchangeable, so individuals suffering from Alzheimer's disease cannot swap out puzzles to continue to stimulate their brain nor can they continue memory training by having images related to their lives (e.g., family members). Therefore, there is a need for an adaptable audiovisual therapy device that provides mental stimulus to improve the treatment of Alzheimer's disease.

### BRIEF SUMMARY

The present invention includes an audiovisual therapy device designed to provide audio and visual stimuli to an individual affected by Alzheimer's disease. In one embodiment, the audiovisual therapy device includes a puzzle assembly designed to play audio files based on a selected piece of the puzzle assembly. In another embodiment, the audiovisual therapy device includes a puzzle assembly designed to determine whether a selected puzzle piece matches an audio file. In yet another embodiment, the audiovisual therapy device includes a puzzle assembly designed to play audio files based on a selected piece of the puzzle assembly and to determine whether a selected puzzle piece matches an audio file.

### BRIEF DESCRIPTION OF THE SEVERAL VIEWS OF THE DRAWINGS

The embodiments illustrated, described, and discussed herein are illustrative of the present invention. As these embodiments of the present invention are described with reference to illustrations, various modifications, or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1A illustrates a top perspective view of an audiovisual therapy device according to one embodiment of the present invention.

FIG. 1B illustrates a front perspective view of an audiovisual therapy device according to one embodiment of the present invention.

FIG. 1C illustrates a side perspective view of an audiovisual therapy device according to one embodiment of the present invention.

FIG. 1D illustrates a bottom perspective view of an audiovisual therapy device according to one embodiment of the present invention.

FIG. 2 illustrates a top perspective view of a top shell of an audiovisual therapy device according to one embodiment of the present invention.

FIG. 3 illustrates a top perspective view of a bottom shell of an audiovisual therapy device according to one embodiment of the present invention.

FIG. 4 illustrates a top perspective view of a bottom shell of an audiovisual therapy device according to one embodiment of the present invention.

FIG. 5 illustrates a schematic diagram of a plurality of near field communication tags positioned on an audiovisual therapy device according to one embodiment of the present invention.

FIG. 6 illustrates an audiovisual therapy device with a plurality of puzzle pieces according to one embodiment of the present invention.

FIG. 7 illustrates a plurality of puzzle pieces according to one embodiment of the present invention.

FIG. 8 illustrates a schematic diagram of a printed circuit board according to one embodiment of the present invention.

FIG. 9 illustrates a schematic diagram of an audiovisual therapy system according to one embodiment of the present invention.

FIG. 10 illustrates a schematic diagram of an audiovisual therapy system according to one embodiment of the present invention.

FIG. 11 illustrates a schematic diagram of a remote server of an audiovisual therapy system according to one embodiment of the present invention.

FIG. 12 illustrates a schematic diagram of a personal computer of an audiovisual therapy system according to one embodiment of the present invention.

FIG. 13 illustrates a schematic diagram of a mobile device of an audiovisual therapy system according to one embodiment of the present invention.

FIG. 14 illustrates a schematic diagram of an internet-of-things (IoT) device according to one embodiment of the present invention.

### DETAILED DESCRIPTION

For the purposes of promoting an understanding of the present disclosure, reference will be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “a composite” means at least one composite and can include more than one composite.

Throughout the specification, the terms “about” and/or “approximately” may be used in conjunction with numerical values and/or ranges. The term “about” is understood to mean those values near to a recited value. For example, “about 40 [units]” may mean within +/−25% of 40 (e.g., from 30 to 50), within +/−20%, +/−15%, +/−10%, +/−9%, +/−8%, +/−7%, +/−6%, +/−5%, +/−4%, +/−3%, +/−2%, +/−1%, less than +/−1%, or any other value or range of values therein or there below. Furthermore, the phrases “less than about [a value]” or “greater than about [a value]” should be understood in view of the definition of the term “about” provided herein. The terms “about” and “approximately” may be used interchangeably.

As used herein, the verb “comprise” as is used in this description and in the claims and its conjugations are used in its non-limiting sense to mean that items following the word are included, but items not specifically mentioned are not excluded.

Throughout the specification the word “comprising,” or variations such as “comprises” or “comprising,” will be understood to imply the inclusion of a stated element, integer or step, or group of elements, integers, or steps, but not the exclusion of any other element, integer or step, or group of elements, integers or steps. The present disclosure may suitably “comprise”, “consist of”, or “consist essentially of”, the steps, elements, and/or reagents described in the claims.

It is further noted that the claims may be drafted to exclude any optional element. As such, this statement is intended to serve as antecedent basis for use of such exclusive terminology as “solely”, “only”, and the like in connection with the recitation of claim elements, or the use of a “negative” limitation.

Unless defined otherwise, all technical and scientific terms used herein have the same meanings as commonly understood by one of ordinary skill in the art to which this disclosure belongs. Preferred methods, devices, and materials are described, although any methods and materials similar or equivalent to those described herein can be used in the practice or testing of the present disclosure. All references cited herein are incorporated by reference in their entirety.

The subject matter described herein includes an audiovisual therapy device designed to provide audio and visual stimuli for improving the emotional well-being and cognitive ability of an individual. In one embodiment, the audiovisual therapy device includes a jigsaw puzzle assembly designed to play recorded audio files. In another embodiment, the audiovisual therapy device includes a jigsaw puzzle assembly and a plurality of electronic sensors designed to play custom sounds based on the positioning of the jigsaw puzzle. Advantageously, the audiovisual therapy device is designed for network communication (e.g., Bluetooth®, Wi-Fi®, and/or near-field communication (NFC)) and is operable to receive a plurality of audio files from at least one remote device. For example, and not limitation, the at least one remote device includes, but is not limited to, a cell phone, a computer, a laptop, a television, and other remote devices. The remote device is configured to capture audio files and identify a corresponding plurality of puzzle pieces. The remote device further includes a software platform configured to receive a plurality of images and audio files relating to a plurality of puzzle pieces. Advantageously, the present invention is operable to create a plurality of puzzles with multiple combinations of images and audio files via the software platform. In yet another embodiment, the present invention includes a virtual representation of an audiovisual therapy device. For example, and not limitation, the present invention includes a software platform and/or mobile application for displaying and interacting with a virtual representation of an audiovisual therapy device via an interface of a remote device.

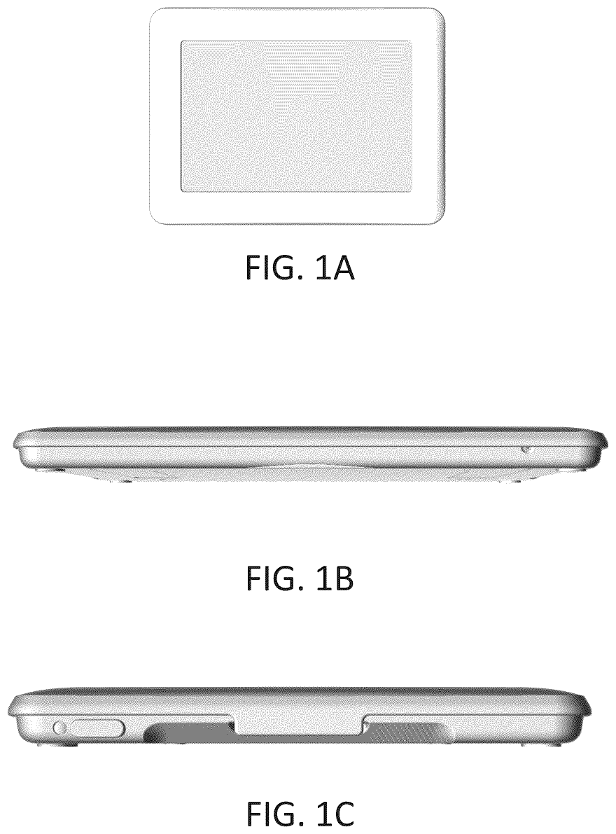

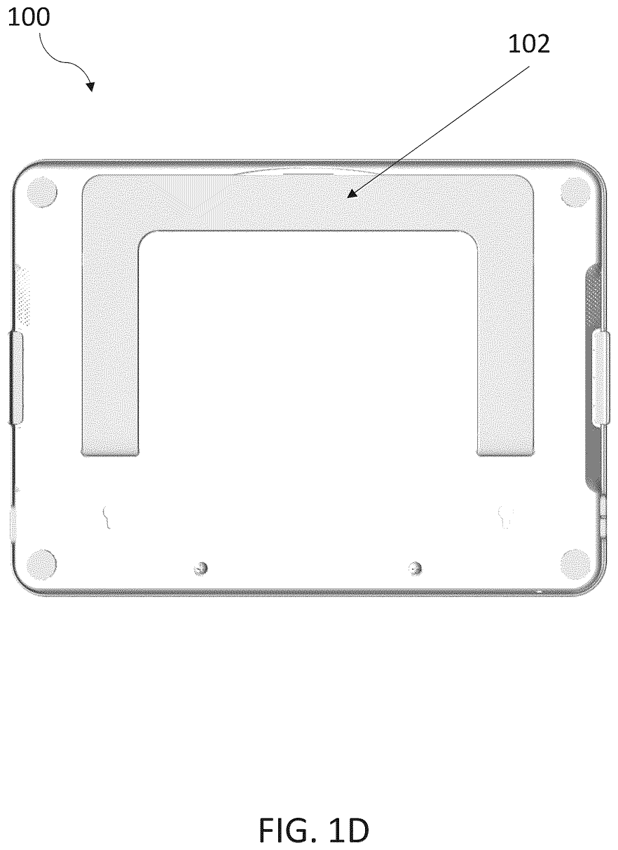

FIGS. 1A-1D illustrate various perspectives of an audiovisual therapy device according to one embodiment of the present invention. FIG. 1A illustrates a top perspective of an audiovisual therapy device according to one embodiment of the present invention. FIG. 1B illustrates a front perspective view of an audiovisual therapy device according to one embodiment of the present invention. FIG. 1C illustrates a side perspective view of an audiovisual therapy device according to one embodiment of the present invention. FIG. 1D illustrates a bottom perspective view of an audiovisual therapy device with a frame stand 102. The frame stand 102 is attached to an external surface of the bottom shell. Advantageously, the frame stand is operable to move between an extended position and a closed position. In the extended position, the frame stand 102 extends away from the frame to support the frame on a surface (e.g., a table). In the closed position, the frame stand is recessed in the bottom shell.

In one embodiment, the present invention includes an audiovisual therapy device including a frame assembly comprising a top shell and a bottom shell, a printed circuit board assembly including control electronics, at least one power supply component, a plurality of fasteners, a plurality of speakers, a plurality of speaker mounts, and a frame stand. For example, and not limitation, the top shell and the bottom shell are removably attached to each other via the plurality of fasteners (e.g., snap mechanism, clip, screws). Positioned between the top shell and the bottom shell is a layer of material designed to receive a plurality of puzzle pieces. The audiovisual therapy device further includes at least one button positioned underneath the layer of material. When at least one puzzle piece is attached to the layer of material, the puzzle piece is operable to come into contact with the at least one button. The printed circuit board assembly is positioned between the top shell and the bottom shell. The bottom shell further houses the at least one power supply component, the plurality of speakers, and the plurality of speaker mounts. The frame stand is positioned in a recessed portion of an exterior surface of the bottom shell. The printed circuit board assembly is operable for network communication (e.g., antenna) and to control the at least one power supply component, the plurality of speakers, and/or the frame stand. In one embodiment, the control electronics includes at least one antenna, which allows the audiovisual therapy device to send information (e.g., puzzle data) to at least one remote device (e.g., smartphone, tablet, laptop computer) and/or receive information (e.g., image files, audio files) from at least one remote device. The at least one antenna provides wireless communication, standards-based or non-standards-based, by way of example and not limitation, radiofrequency (RF), Bluetooth, ZigBee, near field communication (NFC), or similar commercially used standards.

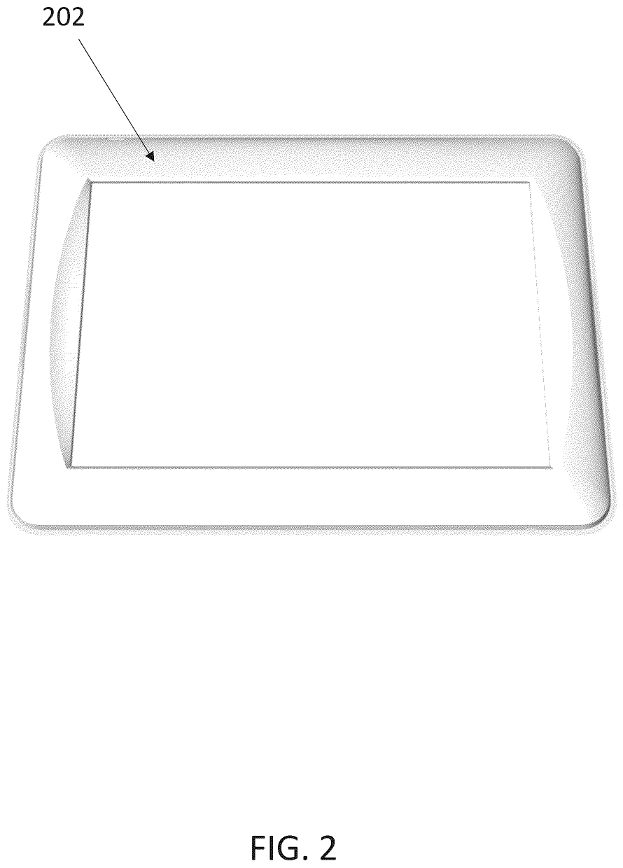

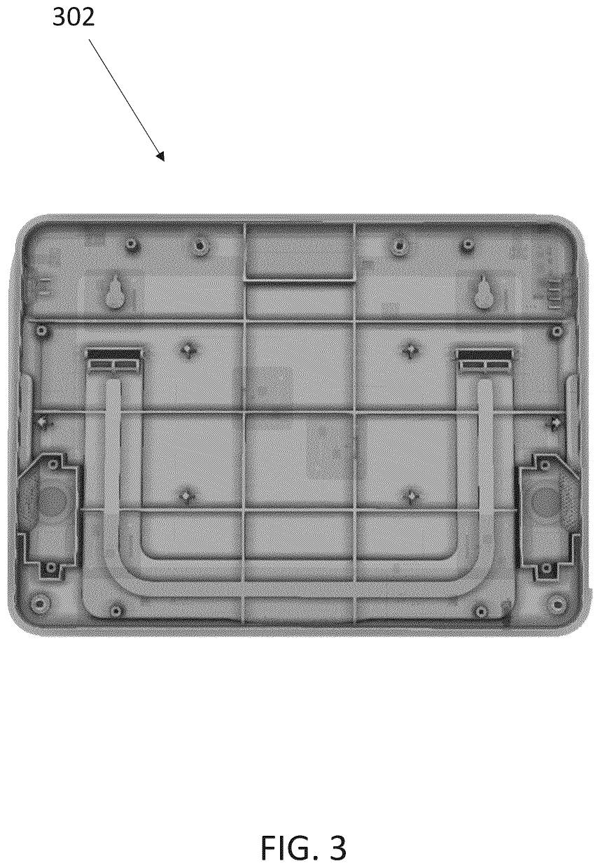

FIG. 2 illustrates a top perspective view of a top shell 202 of an audiovisual therapy device according to one embodiment of the present invention. FIG. 3 illustrates a top perspective view of a bottom shell 302 of an audiovisual therapy device according to one embodiment of the present invention.

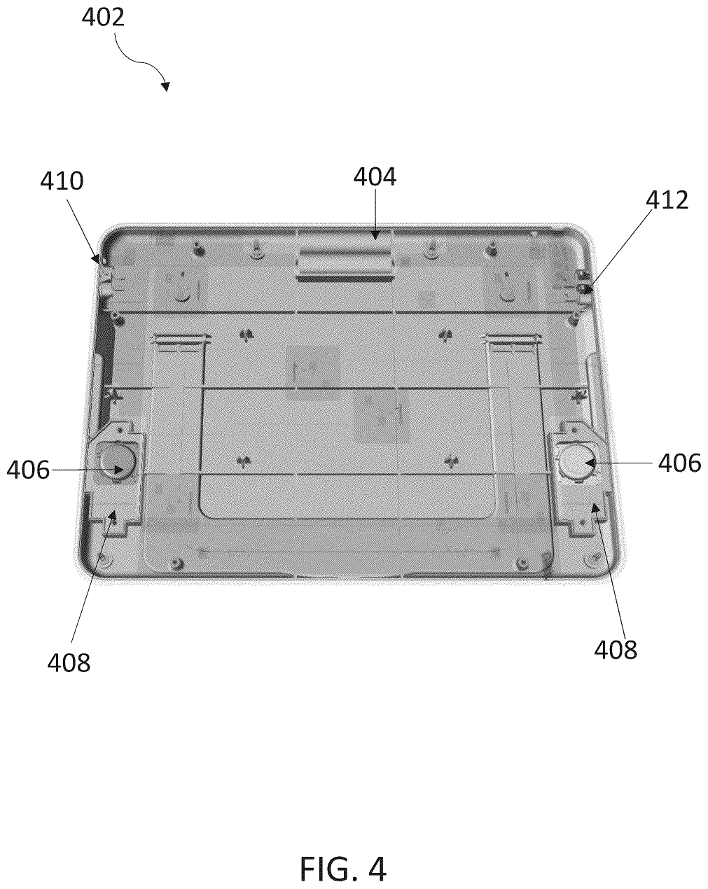

As shown in FIG. 4, the bottom shell 402 houses the at least one power supply component 404, the plurality of fasteners, the plurality of speakers 406, the plurality of speaker mounts 408, a power button 410, and a plurality of volume buttons 412. In one embodiment, the top shell and the bottom shell are removably attached to each other via at least one fastener (e.g., screw), a snapping mechanism, a magnetic mechanism, or other similar attachment devices and methods. For example, and not limitation, the at least one power supply component includes at least one battery. For further example, and not limitation, in some embodiments, the at least one battery includes a rechargeable battery. Alternatively, the at least one battery includes a non-rechargeable battery. For further example, and not limitation, the at least one battery includes a lithium battery. In yet another embodiment, the at least one power supply component includes a plurality of power supply components.

In one embodiment, the audiovisual therapy device is operable for network communication including, but not limited to, near-field communication, Bluetooth, and/or Wi-Fi. The audiovisual therapy device further includes at least one pairing button and a pairing indicator for activating and indicating Bluetooth pairing. For example, and not limitation, the pairing indicator includes a light emitting diode (LED). After the pairing button is pressed and a successful Bluetooth connection is made with a remote device, the LED activates after receiving an activation command from the printed circuit board assembly. The LED is further operable to indicate the charge level of the audiovisual device.

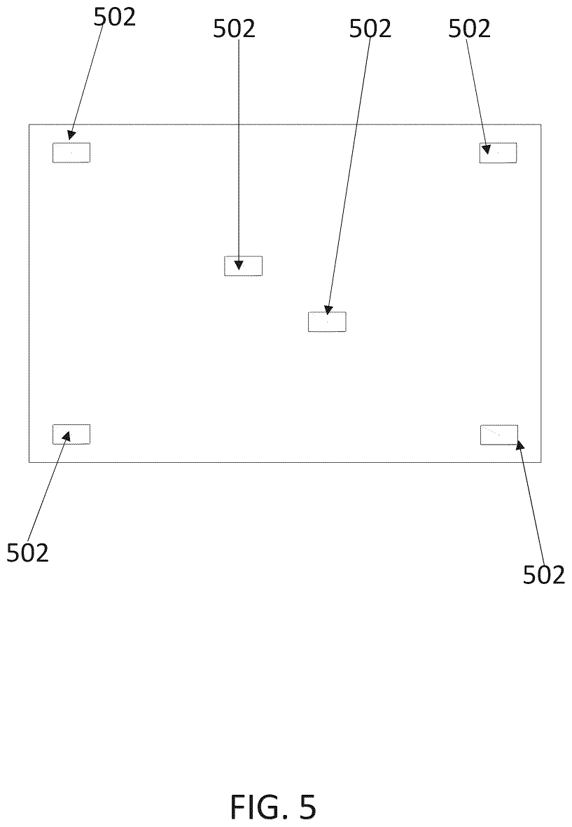

In one embodiment, as shown in FIG. 5, the audiovisual therapy device includes an array of near-field communication (NFC) readers 502. The audiovisual therapy device is operable to send and receive audio files via the array of NFC readers. In some embodiments, the audiovisual therapy device includes at least one NFC tag attached to the back of an image, puzzle, puzzle piece, or other visual tool. For further example, in some embodiments, the audiovisual therapy device includes an NFC tag sheet with a plurality of NFC tags attached to the back of an image and/or a puzzle. The audiovisual therapy device further includes a transparent protection layer positioned behind the NFC tag sheet to protect the NFC tag sheet from external elements while still allowing light to pass through. For further example, and not limitation, the NFC tag includes, but is not limited to, an NFC tag chip, a single-interface NFC chip, a dual-interface NFC chip, and/or a NFC controller chip. The array of NFC readers is operable for wireless communication with the plurality of NFC tags. For example, and not limitation, the array of NFC readers is operable to determine a puzzle corresponding to an NFC tag and identify a corresponding audio file from a remote device or stored in the memory. The array of NFC readers is further operable to identify a plurality of audio files corresponding to a puzzle based on a plurality of NFC tags. For example, when a puzzle has a plurality of separate images and an NFC tag corresponding to each separate image, the plurality of NFC readers is operable to determine a corresponding audio file for each separate image. The plurality of NFC readers is further operable to transmit a command to the printed circuit board and/or the speaker to play the corresponding audio file when the puzzle piece is inserted into the frame assembly and/or a puzzle piece is pressed.

In some embodiments, the audiovisual therapy device is designed for capacitive touch. For example, and not limitation, the audiovisual therapy device includes a screen or display operable to detect pressure (e.g., a user touches a puzzle piece) applied to the screen. For further example, and not limitation, the audiovisual therapy device includes a liquid-crystal display (LCD) touch screen. Alternatively, or additionally, the audiovisual therapy device includes a plurality of puzzle pieces designed for capacitive touch. For example, and not limitation, each puzzle piece of the plurality of puzzle pieces includes an LCD layer designed for capacitive touch. In yet another embodiment, the present invention includes a LCD screen with a plurality of capacitive touch puzzle pieces positioned on top of the LCD screen. The audiovisual therapy device is further operable to provide a tactile sound when a button is pushed and/or when a puzzle piece is attached to the audiovisual therapy device. The audiovisual therapy device further includes a lighting mechanism under each puzzle piece. For example, and not limitation, the lighting mechanism is operable to generate a light or similar visual indicator when a corresponding piece is pressed and/or a command is received from a remote device. In one embodiment, the audiovisual therapy device includes a plurality of electromagnets to align and/or hold puzzle pieces in place. For further example, and not limitation, the audiovisual therapy device includes a release button designed to release one or more puzzle pieces. Alternatively, the audiovisual therapy device is in network connection to a remote device and is operable to receive a command from a software platform or mobile application to release one or more puzzle pieces.

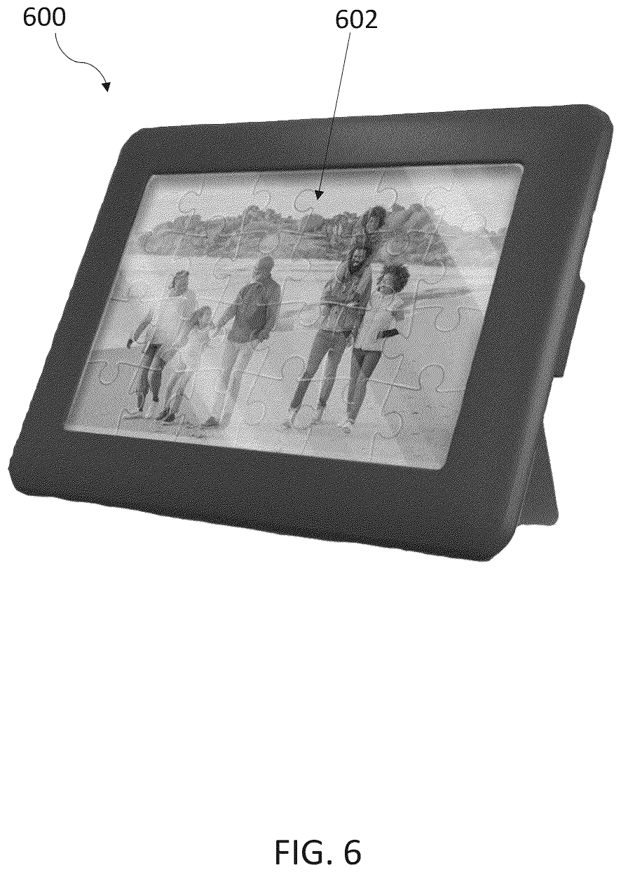

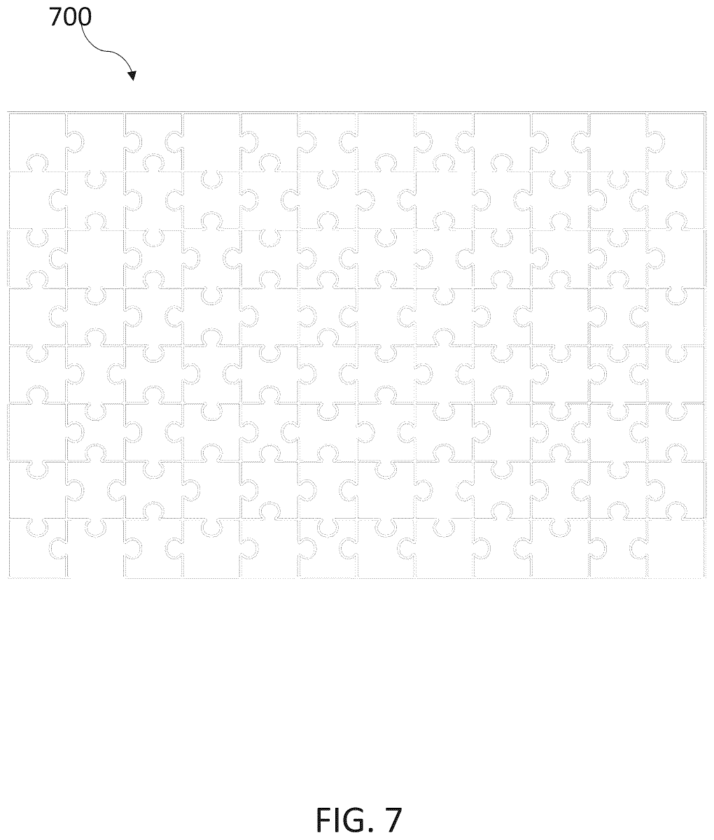

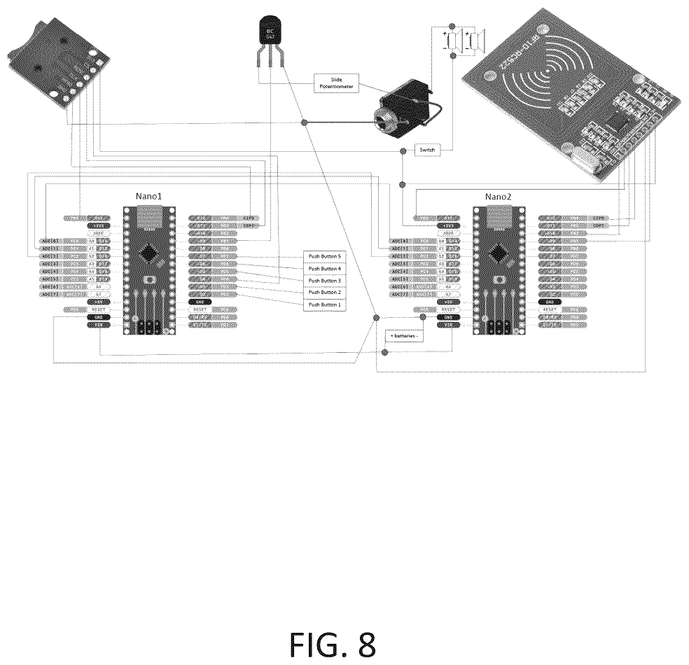

As shown in FIG. 6, in some embodiments, the audiovisual therapy device includes a frame assembly 600 designed to receive a plurality of puzzle pieces 602 and includes a plurality of speakers. FIG. 7 illustrates a plurality of puzzle pieces for the audiovisual therapy device according to one embodiment of the present invention. The audiovisual therapy device is designed to receive audio files via a wired and/or wireless connection. For example, and not limitation, in one embodiment, the audiovisual files include an 8-bit resolution and a 16 KHz sampling rate. The audiovisual therapy device further includes a radiofrequency chip designed to signal which audio file to play.

In another embodiment, the present invention includes an audiovisual therapy device comprising a frame assembly, a memory, a plurality of buttons, a printed circuit board, a radio frequency identification (RFID) reader, control electronics, a headphone jack, and a power supply component. The printed circuit board includes a microcontroller, a wireless communication tag (e.g., an RFID tag, a NFC tag), a power indicator, and a charging indicator. As shown in FIGS. 6 and 7, in some embodiments, the frame assembly includes a puzzle comprising a plurality of puzzle pieces. Each puzzle piece of the plurality of puzzle pieces is designed to connect to at least one other puzzle piece of the plurality of puzzle pieces. In another embodiment, the audiovisual therapy device includes an additional frame holder to display additional puzzles. Alternatively, the RFID reader may be a near-field communication reader.

In one embodiment, the present invention includes an RFID reader configured to receive a frequency from an RFID tag corresponding to at least one puzzle piece of a plurality of pieces. For example, and not limitation, in one embodiment, the present invention includes a frame assembly designed to receive a plurality of puzzle pieces and a plurality of buttons positioned underneath the plurality of puzzle pieces. A corner puzzle piece includes an RFID tag with a unique identifier. The frame assembly further includes an RFID reader designed to identify the RFID tag based on the unique identifier. Advantageously, the RFID tag corresponds to at least one audio file. The present invention is further operable to play the corresponding audio file when at least one button of the frame assembly is pressed.

In yet another embodiment, the puzzle includes a plurality of images. Each image of the plurality of images is positioned in a separate sub-area of the puzzle. Advantageously, each sub-area has a button connected via the printed circuit board to the memory. When the button is pressed, a signal is sent to the memory to play a corresponding audio file. The present invention is designed to play the corresponding audio file via at least one speaker and/or the headphone jack. In another embodiment, the plurality of buttons is uniformly distributed across the frame assembly. In yet another embodiment, the frame assembly further includes at least one light attached to the frame assembly. The at least one light is configured to activate when at least one button is triggered. Advantageously, in one embodiment, the at least one light is designed to activate only when a corresponding button is triggered.

The present invention is further operable to identify which puzzle piece is selected. For example, and not limitation, in one embodiment, the frame assembly includes an RFID reader in a bottom corner. The RFID reader is designed to receive a signal from at least one RFID chip corresponding to a puzzle attached to the frame assembly. The RFID reader is designed to transmit a signal to the memory that indicates which audio file corresponds to the puzzle attached to the frame assembly. Alternatively, the frame assembly is configured to determine an audio file corresponding to a plurality of puzzle pieces using a light sensor, a noise sensor, a motion sensor, and other similar sensors. The frame assembly is further configured for Bluetooth communication, Wi-Fi communication, Zigbee communication, near field communication, and other similar forms of communication. The frame assembly is further configured to determine when at least one button positioned underneath the puzzle has been pressed and play an audio file corresponding to the pressed button. Alternatively, in some embodiments, the RFID reader is an NFC Reader and the at least one RFID chip is at least one NFC tag.

In yet another embodiment, the frame assembly includes at least one button on the surface of the frame assembly such that the at least one button is engaged by at least one puzzle piece of a plurality of puzzle pieces being placed on the surface. In one embodiment, a wireless communication tag (e.g., radio frequency identification (RFID) or near-field communication (NFC)) is attached to at least one puzzle piece. For example, and not limitation, at least five puzzle pieces include a wireless communication tag. In another embodiment, each puzzle piece of the plurality of puzzle pieces includes a wireless communication tag. In yet another embodiment, each wireless communication tag is removably attached to the plurality of puzzle pieces. Alternatively, each wireless communication tag is permanently attached to the plurality of puzzle pieces. Each wireless communication tag is unique to a puzzle piece and corresponds to an audio file. In one embodiment, each wireless communication tag is matched to an audio file via a remote device. The frame assembly further includes a wireless communication reader (e.g., RFID reader, NFC reader) designed to receive a signal from each wireless communication tag. The wireless communication reader is further configured to transmit a signal to the remote device indicating each wireless communication tag associated with a plurality of puzzle pieces. In some embodiments, the remote device is further designed to match an audio file and a wireless communication tag and/or puzzle piece based on a selection via a user interface of the remote device. The remote device is designed to transmit the matched audio file data and the matched wireless communication tag data to the memory of the frame assembly.

Advantageously, this enables the frame assembly to receive different pluralities of puzzle pieces and to update the audio files based on the plurality of puzzle pieces. The frame assembly is designed to play a corresponding audio file when at least one button corresponding to a puzzle piece is triggered.

In yet another embodiment, the frame assembly includes a ⅛ inch plywood sheet, a 1/16 inch plywood sheet, a 1/16 inch rubber sheet, a push button (e.g., a 6×6×4.3 push button), a switch, a 3.5 mm jack, a slide potentiometer, a secure digital (SD) board, at least one speaker (e.g., a 3 Watt 8 Ohm speaker), a transistor (e.g., a BC547 transistor), an Arduino Nano printed circuit board, an RFID reader, an RFID tag, a Wi-Fi module, a Bluetooth module, and a screw (e.g., M1. 2×3 screw). In one embodiment, the push button includes a tactile push button with 4 pins. In another embodiment, the switch includes a two-way switch (e.g., high knob vertical slide switch). The potentiometer is designed for volume adjustment and/or control.

In another embodiment, the printed circuit board includes an Arduino Nano circuit board. The SD card includes a Micro SD card reader module. The printed circuit board further includes a near-field communication (NFC) tag. The RFID reader includes a Qunqi 5Pcs RC522 IC Card Module with S50 White Card and Key Ring for Arduino Raspberry Pi. The speaker includes a CQRobot Speaker 3-Watt 8 Ohm that is compatible with an Arduino Motherboard and a JST-PH2.0 Interface. The Bluetooth module includes a CSR BC417 Bluetooth chip and Bluetooth V2.0 SPP protocol standards. The WIFI module includes an integrated chip designed for network communication.

In another embodiment, the frame assembly is designed to receive a command to play an audio file via a button attached to the frame assembly. In one embodiment, the command is received from at least one remote device. The audio file corresponds to at least one image of the jigsaw puzzle. The frame assembly is further operable to receive a selection of at least one image of the frame assembly via a button positioned underneath the puzzle. The audiovisual therapy device is designed to emit a sound based on the selected image. For example, and not limitation, if the selected image matches the audio file, then the present invention is designed to emit a positive sound (e.g., “correct” or a celebration noise). If the selected image does not match the audio file, then the audiovisual therapy device is designed to emit a sound to indicate the incorrect selection (e.g., “Try again”).

In another embodiment, the frame assembly includes a screen configured to display a virtual representation of a puzzle. The frame assembly is further operable to display an unassembled version of the puzzle and receive user input for a position of each puzzle piece of the plurality of puzzle pieces. The frame assembly is further operable to identify when a user has selected an incorrect position for a puzzle piece. The frame assembly is further designed to receive a plurality of virtual puzzles via a remote device and display a new virtual puzzle after a user completes a first virtual puzzle. Advantageously, the frame assembly is operable to generate at least one prompt for a user. For example, and not limitation, in one embodiment, the prompt indicates at least one image for a user to select (e.g., select the puzzle pieces with an image of a user's son). Alternatively, the virtual representation is created and operated via a software platform and/or a mobile application via at least one remote device.

In one embodiment, the present invention includes at least one remote device including a software platform designed to display a virtual representation of at least one puzzle. The at least one remote device includes at least one component designed to capture at least one image data and audio data. The at least one remote device is further operable to receive at least one image and/or audio data from a second remote device and/or via the internet. The at least one remote device is configured to display at least one image via a user interface and to simulate a puzzle or similar visual tool. Advantageously, the at least one remote device is operable to receive a user selection of at least one puzzle via the user interface and a selection of at least one audio file via the user interface. For example, and not limitation, the at least one remote device is designed to correlate at least one audio file and at least one puzzle via drag and click functionality. In another embodiment, the software platform is configured to display a virtual overlay of a puzzle with a plurality of images. The software platform is configured to correlate at least one audio file to each image of the plurality of images. Additionally, the present invention further includes a remote server in network communication with a plurality of audiovisual therapy devices operable to send and receive data from each audiovisual therapy device. Advantageously, puzzles can be shared between multiple audiovisual therapy devices.

In yet another embodiment, the present invention includes an audiovisual therapy device system designed for the customization and generation of a virtual representation of a puzzle piece and/or a puzzle. For example, and not limitation, the present invention includes a software platform in network communication with at least one remote device. The software platform is operable to send and receive commands and data to and from the at least one remote device. For further example, and not limitation, the software platform includes a customization puzzle creation user interface. The customization puzzle creation user interface is designed to control various factors of puzzle making including, but not limited to, the number of puzzle pieces, the amount of an image shown, the shape of the puzzle, the size of the puzzle, background image (e.g., lines of puzzle pieces) and other puzzle features. The software platform is further designed to receive a selected image and/or audio file and attach it to a virtual puzzle piece. After the puzzle is completed, the software platform is operable to transmit and display the created virtual puzzle via the audiovisual therapy device. Advantageously, when the virtual puzzle piece is displayed and engaged via a user interface of the remote device, a second remote device, and/or the audiovisual therapy device, the virtual representation is designed to play a corresponding audio file. The software platform is further operable to display a selected image when the virtual puzzle piece is selected and/or put in the virtual puzzle piece correct portion of the virtual representation. The software platform is further operable to play an audio file corresponding to an incorrect placement of a puzzle piece and/or generate an image corresponding to the puzzle piece placement (e.g., “Wrong” or “Incorrect”).

In some embodiments, the virtual representation of the puzzle includes a game mode. For example, and not limitation, the game mode includes tracking the speed and accuracy of puzzle completion. The software platform is further operable to share the results via social media and other third-party sources. The software platform further compares and tracks users across a plurality of remote devices and a plurality of audiovisual therapy devices. Yet another advantage of the present invention includes tracking the puzzle progress of another user in real-time. Advantageously, this allows family members to watch the progress of a puzzle in real-time.

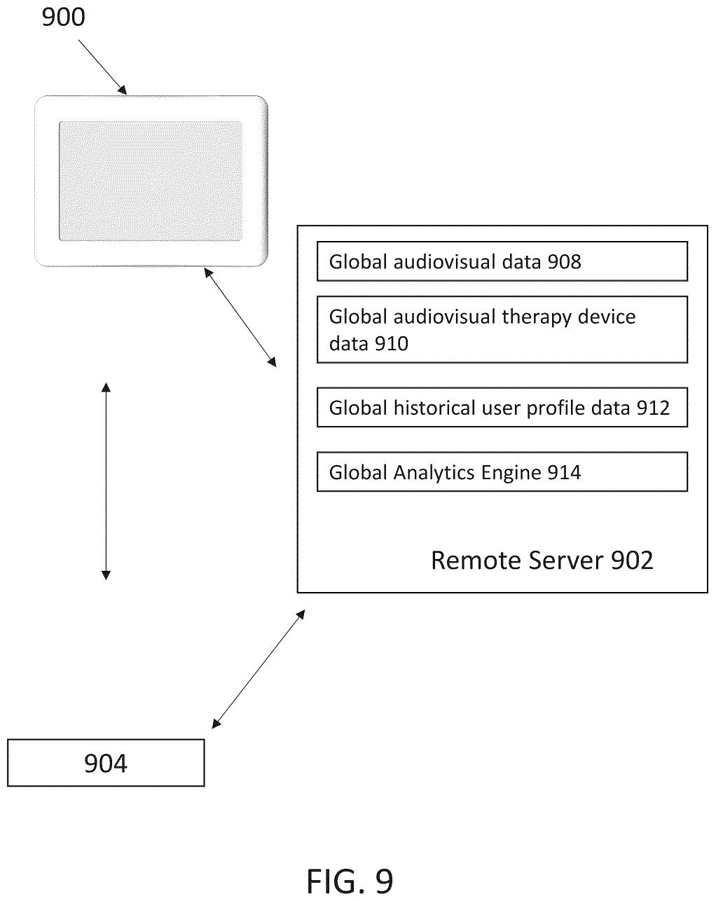

In another embodiment, as shown in FIG. 9, the present invention includes at least one audiovisual therapy device 900, a remote server 902, and a remote device 904 with local storage. The at least one audiovisual therapy device 900, the remote device 904, and the remote server 902 are in network communication. The at least one audiovisual therapy device 900 includes a virtual representation of the audiovisual therapy device and/or a physical embodiment of the audiovisual therapy device. The remote device 904 is preferably a tablet, a smartphone, or similar electronic device. The remote device 904 further includes a processor, an analytics engine, a control interface, and a user interface. The remote device is operable to send and receive data from the audiovisual therapy device and/or the remote server. The remote device stores data in the local storage. The local storage further includes a user profile for the audiovisual therapy device. The user profile includes device preferences (e.g., sound level, brightness), medical information, and puzzle preferences (e.g., music, scenery, size of puzzles) of a user.

The remote server 902 includes global audiovisual data 908, global audiovisual therapy device data 910, global historical user profile data 912, and a global analytics engine 914. The global audiovisual data 908 includes a media library including songs, videos, and other audiovisual data for use with the audiovisual therapy device. The media library is operable to receive data from the at least one remote device, the audiovisual therapy device, and third-party information providers (e.g., web crawlers). The global audiovisual therapy device data 910 includes data captured by a plurality of audiovisual therapy devices. The global audiovisual therapy device data 910 includes device performance data (e.g., battery, screen life) and puzzle data (e.g., puzzle competition, types of puzzles).

The global analytics engine 914 is designed to receive the global audiovisual data 908, the global audiovisual therapy device data 910, the global user profile data 912, and real-time audiovisual therapy device data corresponding to at least one audiovisual therapy device. The global analytics engine 914 is operable to generate at least one recommendation based on the global audiovisual data, the global audiovisual therapy device data, the global user profile data, and real-time audiovisual therapy device data. For example, and not limitation, the global analytics engine is operable to analyze the number of puzzles completed, the completion time for each puzzle, the type of puzzles completed, and other similar metrics. The global analytics engine is further operable to compare the activity of a user profile to one or more other user profiles with similar activity. The global analytics engine is operable to determine that a user needs a new puzzle and further recommends at least one puzzle based on the analyzed data. For example, and not limitation, the global analytics engine is operable to determine that every puzzle a user has completed has nature-related themes. When the nature user needs a new puzzle, the global analytics engine is operable to suggest a nature-related puzzle.

The audiovisual therapy device 900, the remote device 904, and the remote server 902 are designed to connect directly (e.g., Universal Serial Bus (USB) or equivalent) or wirelessly (e.g., Bluetooth®, Wi-Fi®, ZigBee®) through systems designed to exchange data between various data collection sources. In a preferred embodiment, the audiovisual therapy device, the remote device, and the remote server communicate wirelessly through near-field communication.

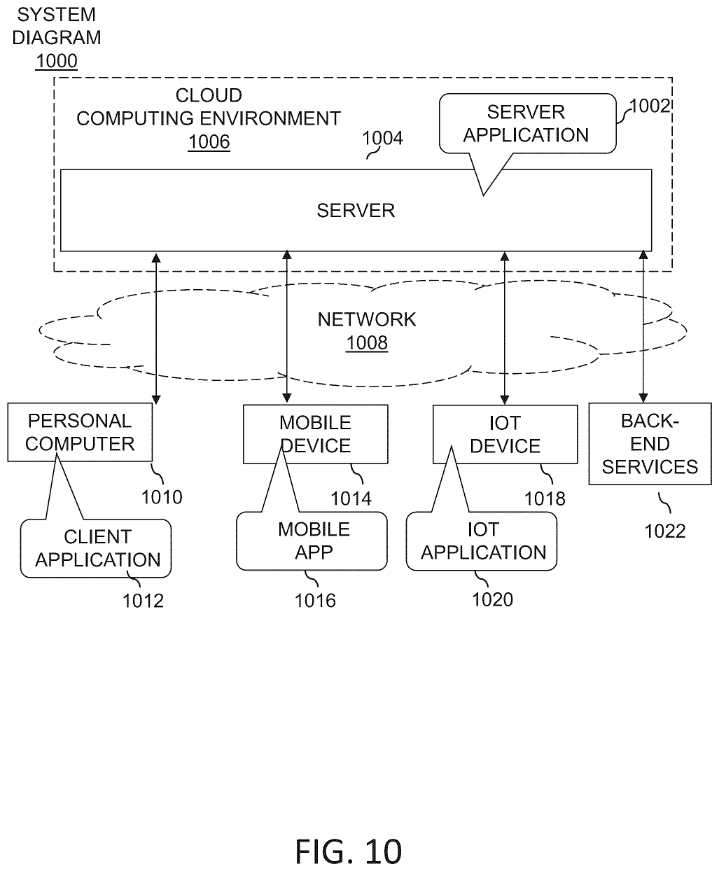

FIG. 10 depicts a system diagram 1000 illustrating a client/server architecture in accordance with embodiments of the present disclosure. The server application 1002 is configured to provide a mobile application for the audiovisual therapy device. A server application 1002 is hosted on a remote server 1004 within a cloud computing environment 1006. The server application 1002 is provided on a non-transitory computer-readable medium including a plurality of machine-readable instructions, which when executed by one or more processors of the server 1004, are adapted to cause the server 1004 to generate the video platform and mobile application. By way of example, and not limitation, the processor of the remote server, remote device, and/or audiovisual therapy device may be a general-purpose microprocessor (e.g., a central processing unit (CPU)), a graphics processing unit (GPU), a microcontroller, an application specific integrated circuit (ASIC), a digital signal processor (DSP), a programmable logic device (PLD), a field programmable gate array (FPGA), a controller, or any other suitable entity or combinations thereof that can perform calculations, process instructions for execution, and/or other manipulations of information.

The server application 1002 is configured to communicate over a network 1008. In a preferred embodiment, the network 1008 is the Internet. In other embodiments, the network 1008 may be restricted to a private local area network (LAN) and/or private wide area network (WAN). The network 1008 provides connectivity with a plurality of client devices including a personal computer 1010 hosting a client application 1012, a mobile device 1014 hosting a mobile app 1016. The network 1008 also provides connectivity for an Internet-Of-Things (IoT) device 1018 hosting an IoT application 1020 and to back-end services 1022. For example, and not limitation, the IoT device 1018 includes the audiovisual therapy device.

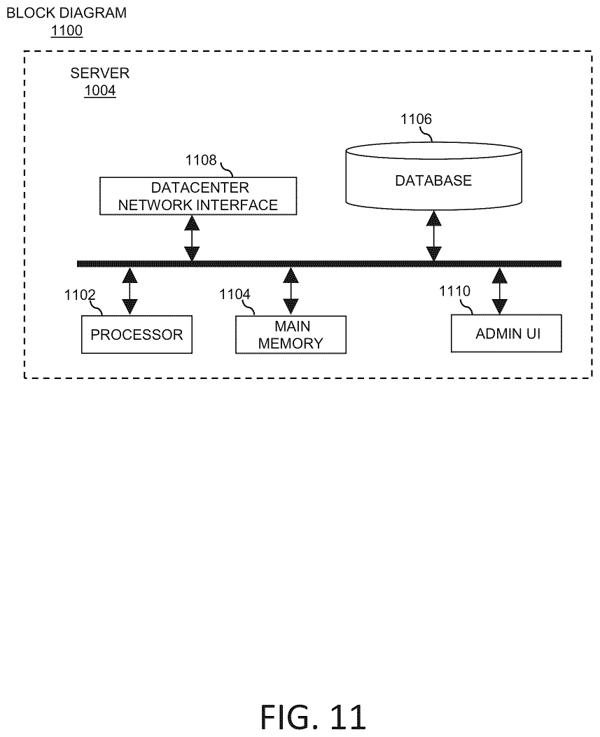

FIG. 11 depicts a block diagram 1100 of the server 1004 of FIG. 10 for hosting at least a portion of the server application 1002 of FIG. 10 in accordance with embodiments of the present disclosure. The server 1004 may be any of the hardware servers referenced in this disclosure. The server 1004 may include at least one of a processor 1102, a main memory 1104, a database 1106, a datacenter network interface 1108, and an administration user interface (UI) 1110. The server 1004 may be configured to host one or more virtualized servers. For example, the virtual server may be an Ubuntu® server or the like. The server 1004 may also be configured to host a virtual container. For example, the virtual server may be the DOCKER® virtual server or the like. In some embodiments, the virtual server and or virtual container may be distributed over a plurality of hardware servers using hypervisor technology.

The processor 1102 may be a multi-core server class processor suitable for hardware virtualization. The processor 1102 may support at least a 64-bit architecture and a single instruction multiple data (SIMD) instruction set. The memory 1104 may include a combination of volatile memory (e.g., random access memory) and non-volatile memory (e.g., flash memory). The database 1106 may include one or more hard drives.

The datacenter network interface 1108 may provide one or more high-speed communication ports to the data center switches, routers, and/or network storage appliances. The datacenter network interface may include high-speed optical Ethernet, InfiniBand (IB), Internet Small Computer System Interface iSCSI, and/or Fibre Channel interfaces. The administration UI may support local and/or remote configuration of the server by a data center administrator.

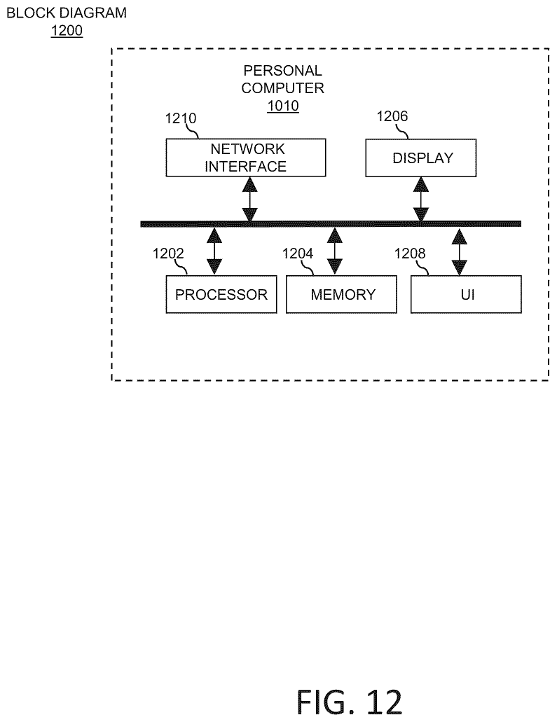

FIG. 12 depicts a block diagram 1200 of the personal computer 1010 of FIG. 10 in accordance with embodiments of the present disclosure. The personal computer 1010 may be any of the devices referenced in this disclosure. The personal computer 1010 may include at least a processor 1202, a memory 1204, a display 1206, a user interface (UI) 1208, and a network interface 1210. The personal computer 1210 may include an operating system to run a web browser and/or the client application 1012 shown in FIG. 10. The operating system (OS) may be a Windows® OS, a Macintosh® OS, or a Linux® OS. The memory 1204 may include a combination of volatile memory (e.g., random access memory) and non-volatile memory (e.g., solid state drive and/or hard drives).

The network interface 1210 may be a wired Ethernet interface or a Wi-Fi interface. The personal computer 1010 may be configured to access remote memory (e.g., network storage and/or cloud storage) via the network interface 1210. The UI 1208 may include a keyboard, and a pointing device (e.g., mouse). The display 1206 may be an external display (e.g., computer monitor) or internal display (e.g., laptop). In some embodiments, the personal computer 1210 may be a smart TV. In other embodiments, the display 1206 may include a holographic projector.

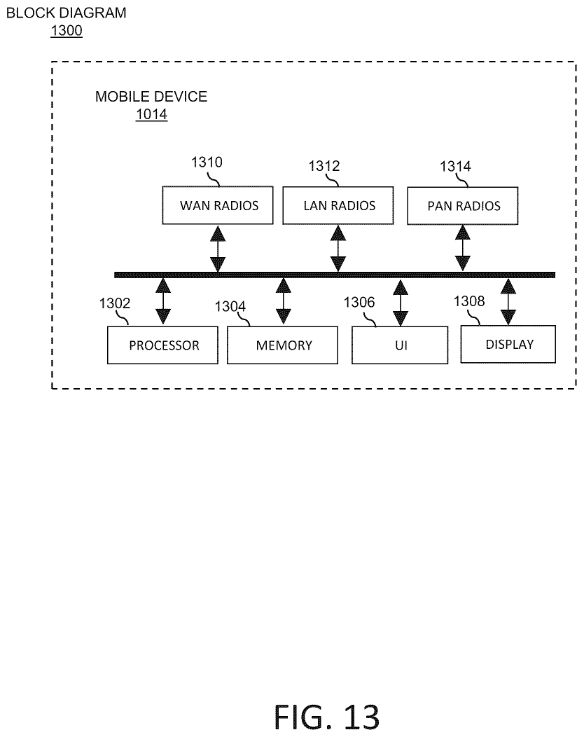

FIG. 13 depicts a block diagram 1300 of the mobile device 1014 of FIG. 10 in accordance with embodiments of the present disclosure. The mobile device 1014 may be any of the remote devices referenced in this disclosure. The mobile device 1014 may include an operating system to run a web browser and/or the mobile app 1016 shown in FIG. 10. The mobile device 1014 may include at least a processor 1302, a memory 1304, a UI 1306, a display 1308, WAN radios 1310, LAN radios 1312, and personal area network (PAN) radios 1314. In some embodiments the mobile device 1314 may be an iPhone® or an iPad®, using iOS® as an OS. In other embodiments the mobile device 1314 may be a mobile terminal including Android® OS, BlackBerry® OS, Chrome® OS, Windows Phone® OS, or the like.

In some embodiments, the processor 1302 may be a mobile processor such as the Qualcomm® Snapdragon™ mobile processor. The memory 1304 may include a combination of volatile memory (e.g., random access memory) and non-volatile memory (e.g., flash memory). The memory 1304 may be partially integrated with the processor 1304. The UI 1306 and display 1308 may be integrated such as a touchpad display. The WAN radios 1310 may include 2G, 3G, 4G, and/or 5G technologies. The LAN radios 1312 may include Wi-Fi technologies such as 802.11a, 802.11b/g/n, and/or 802.11ac circuitry. The PAN radios 1314 may include Bluetooth® technologies.

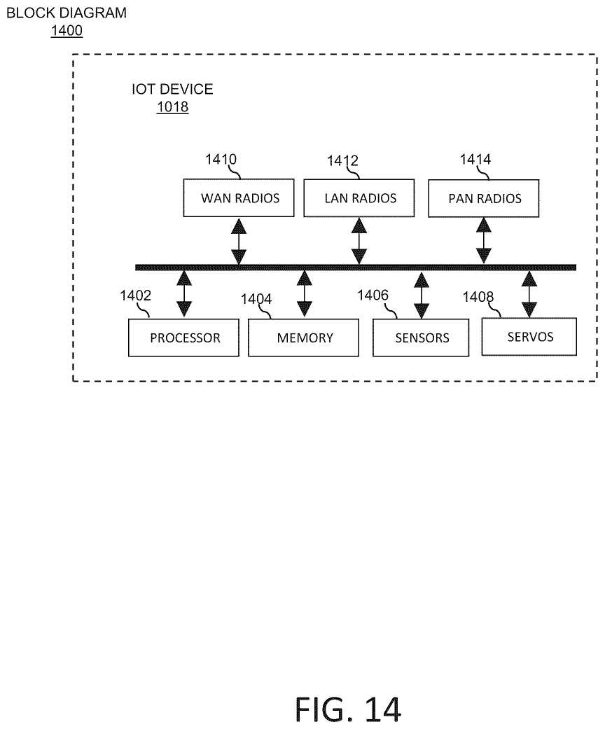

FIG. 14 depicts a block diagram 1400 of the IoT device 1018 of FIG. 10 in accordance with embodiments of the present disclosure. The IoT device 1018 may be any of the remote devices referenced in this disclosure. The IoT device 1018 includes a processor 1402, a memory 1404, sensors 1406, servos 1408, WAN radios 1410, LAN radios 1412, and PAN radios 1414. The processor 1402, a memory 1404, WAN radios 1410, LAN radios 1412, and PAN radios 1414 may be of similar design to the processor 1302, a memory 1304, WAN radios 1310, LAN radios 1312, and PAN radios 1314 of the mobile device 1014 of FIG. 13. The sensors 1406 and servos 1408 may include any applicable components related to IoT devices such as a monitoring device, an autonomous vehicle, a home assistant, a smart appliance, a medical device, a virtual reality device, an augmented reality device, or the like.

Any combination of one or more computer-readable medium(s) may be utilized. The computer-readable medium may be a computer readable signal medium or a computer-readable storage medium (including, but not limited to, non-transitory computer-readable storage media). A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, SAS, Tensorflow, CUDA, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

These computer program instructions may be provided to a processor of a general-purpose computer, special purpose computer, or other programmable data processing apparatus to produce a machine, such that the instructions, which execute via the processor of the computer or other programmable data processing apparatus, create an ability for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An audiovisual therapy device for mental stimulation, the audiovisual therapy device comprising:
a plurality of puzzle pieces that, when assembled, form an image; and
a frame assembly designed to receive the plurality of puzzle pieces in an assembled format on a surface of the frame assembly,
wherein the frame assembly includes a top shell and a bottom shell, wherein the top shell and the bottom shell are removably attached,
wherein the frame assembly further includes a memory, a processor, at least one speaker, an antenna, at least one control feature, at least one button, and at least one power supply component,
wherein the at least one button is positioned underneath the top shell, wherein the at least one button is operable to engage a puzzle piece positioned on the frame assembly,
wherein the at least one button is communicatively coupled to the memory, and
wherein, after the at least one button is pressed, the frame assembly is designed to play an audio file corresponding to the at least one button via the at least one speaker.

2. The audiovisual therapy device of claim 1, wherein the frame assembly further includes a plurality of sub-areas, wherein each sub-area of the plurality of sub-areas is designed to receive a separate plurality of puzzles, wherein each separate plurality of puzzles includes an image.

3. The audiovisual therapy device of claim 2, wherein the at least one button further includes a plurality of buttons, wherein at least one button of the plurality of buttons corresponds to at least one sub-area of the plurality of sub-areas.

4. The audiovisual therapy device of claim 1, wherein the frame assembly includes a plurality of near-field communication (NFC) readers, wherein the plurality of NFC readers are operable for network communication with at least one remote device.

5. The audiovisual therapy device of claim 4, wherein the frame assembly is designed to receive at least one audio file from the at least one remote device, wherein the at least one audio file corresponds to the plurality of puzzle pieces.

6. The audiovisual therapy device of claim 1, wherein the frame assembly further includes a plurality of sub-areas, a plurality of buttons, and a plurality of near-field communication (NFC) readers, wherein each sub-area is designed to receive a separate plurality of puzzle pieces, wherein each separate plurality of puzzle pieces includes an image, wherein at least one button of the plurality of buttons is positioned underneath each sub-area of the plurality of sub-areas.

7. The audiovisual therapy device of claim 6, wherein each separate plurality of puzzle pieces includes at least one NFC tag, wherein the plurality of NFC readers is operable to determine a corresponding audio file for each plurality of puzzle pieces based on the at least one NFC tag, wherein the frame assembly receives audio data from at least one remote device via the plurality of NFC readers, wherein the audio data includes the corresponding audio file, wherein, when a puzzle piece corresponding to a separate plurality of puzzle pieces is pressed, the frame assembly is designed to play the corresponding audio file via the at least one speaker.

8. An audiovisual therapy device system for mental stimulation, the audiovisual therapy device system comprising:
a plurality of puzzle pieces that, when assembled, form an image;
at least one remote device; and
a frame assembly designed to receive the plurality of puzzle pieces in an assembled format on a surface of the frame assembly,
wherein the frame assembly includes a top shell, a bottom shell, a memory, a memory, a processor, at least one speaker, at least one antenna, at least one control feature, and at least one power supply component,
wherein the top shell and the bottom shell are removably attached to each other,
wherein the memory, the processor, the at least one speaker, the at least one antenna, and the at least one power supply component are positioned between the top shell and the bottom shell,
wherein the frame assembly further includes at least one button on the surface of the frame assembly such that the at least one button is engaged by a puzzle piece being placed on the surface,
wherein the at least one remote device is in network communication with the frame assembly,
wherein the at least one remote device is configured to capture and transmit a plurality of audio files to the frame assembly,
wherein the at least one button is communicatively coupled to the memory,
wherein the memory includes the plurality of audio files received from the at least one remote device, and
wherein, after the at least one button is pressed, the frame assembly is designed to play an audio file of the plurality of audio files corresponding to the at least one button via the at least one speaker.

9. The audiovisual therapy device system of claim 8, wherein the frame assembly further includes a plurality of sub-areas, wherein each sub-area of the plurality of sub-areas is designed to receive a separate plurality of puzzles, wherein each separate plurality of puzzles includes an image.

10. The audiovisual therapy device system of claim 9, wherein the at least one button further comprises a plurality of buttons, wherein at least one button of the plurality of buttons corresponds to at least one sub-area of the plurality of sub-areas.

11. The audiovisual therapy device system of claim 10, wherein each button of the plurality of buttons corresponds to a different audio file.

12. The audiovisual therapy device system of claim 9, wherein the plurality of audio files includes at least one audio file corresponding to each sub-area of the plurality of sub-areas.

13. The audiovisual therapy device system of claim 8, wherein the frame assembly further includes a plurality of near-field communication (NFC) readers, wherein the plurality of NFC readers are positioned underneath the plurality of puzzle pieces when assembled.

14. The audiovisual therapy device system of claim 13, wherein the frame assembly further includes a plurality of sub-areas, wherein each sub-area of the plurality of sub-areas is designed to receive a separate plurality of puzzle pieces, wherein each separate plurality of puzzles pieces includes an image and at least one NFC tag, wherein the plurality of NFC readers is operable to determine a corresponding audio file for each separate plurality of puzzle pieces based on the at least one NFC tag, wherein the frame assembly receives audio data from at least one remote device via the plurality of NFC readers, wherein the audio data includes at least one corresponding audio file for a separate plurality of puzzle pieces, wherein, when a puzzle piece corresponding to at least one separate plurality of puzzle pieces is pressed, the frame assembly is designed to play the corresponding audio file via the at least one speaker.

15. An audiovisual therapy device for mental stimulation, the audiovisual therapy device comprising:
a plurality of puzzle pieces that, when assembled, form an image;
a frame assembly designed to receive the plurality of puzzle pieces in an assembled format on a surface of the frame assembly,
wherein the frame assembly includes a memory, a processor, at least one speaker, at least one near-field communication (NFC) reader, at least one control feature, at least one power supply component, and a plurality of sub-areas,
wherein the frame assembly further includes a plurality of buttons on the surface of the frame assembly such that the plurality of buttons is engaged by at least one puzzle piece of the plurality of puzzle pieces being placed on the surface,
wherein the plurality of buttons is communicatively coupled to the memory, and
wherein, after at least one button of the plurality of buttons is pressed, the frame assembly is designed to play an audio file corresponding to the at least one button of plurality of buttons via the at least one speaker.

16. The audiovisual therapy device of claim 15, wherein the plurality of puzzle pieces includes at least five puzzle pieces.

17. The audiovisual therapy device of claim 16, wherein each puzzle piece of the at least five puzzle pieces includes a near-field communication (NFC) tag, wherein the frame assembly is further operable to receive audio file data from at least one remote device, wherein the audio file data includes at least one audio file corresponding to each NFC tag.

18. The audiovisual therapy device of claim 17, wherein the NFC reader is designed to determine which puzzle piece of the at least five puzzle pieces is pressed based on a corresponding NFC tag, wherein, once at least one puzzle piece of the at least five puzzle pieces is pressed, the NFC reader is designed to transmit a signal to the memory, wherein the signal indicates the corresponding NFC tag.

19. The audiovisual therapy device of claim 15, wherein the at least one control feature is designed to activate the frame assembly.

20. The audiovisual therapy device of claim 15, wherein the at least one power supply component includes at least one battery.
